(19) United States
(12) Patent Application Publication
(10) Pub. No.: US 2004/0208458 A1
(43) Pub. Date: Oct. 21, 2004

(54) Bidirectional optical module, optical drop module, and optical transmission device

(76) Inventors: Hitoshi Uno, Yokohama-shi (JP); Hitomaro Tohgoh, Yokohama-shi (JP); Hiroaki Asano, Yokohama-shi (JP)

Correspondence Address: STEVENS DAVIS MILLER & MOSHER, LLP, 1615 L STREET, NW, SUITE 850, WASHINGTON, DC, 20036, US

(21) Appl. No.: 10/719,060

(22) Filed: Nov. 24, 2003

(30) Foreign Application Priority Data
Nov. 26, 2002 (JP) 2002-341928
Feb. 13, 2003 (JP) 2003-35522

(51) Int. Cl. G02B 6/43

(52) U.S. Cl. 385/89; 385/49

(57) ABSTRACT

The invention provides a bidirectional optical module which can enable bidirectional utilization of one optical fiber transmission channel with low-cost, and an optical transmission device using it. This optical module comprises a light receiver, wherein a photo acceptance unit is optically coupled with a light output part obtained by cutting an optical fiber in the middle thereof aslant an optical fiber core, and inserting a filter/half mirror between obtained cross sections of the core; and a light transmitter, wherein a light emitting device is optically coupled with one end of the optical fiber. The light receiver is set to have a receptacle structure having a ferrule in which the other end of the optical fiber is inserted from inside, and which can physically contact with an optical connector.

### BACKGROUND OF THE INVENTION

1. Technical Field

The present invention relates to a bidirectional optical module which enables bidirectional usage of one optical fiber transmission channel, an optical drop module, and an optical transmission device using them.

2. Background Art

Recently, a scope of optical fiber communications using semiconductor lasers has expanded to various areas, such as LAN (local area network) and FTTH (fiber to the home). In the LAN and the FTTH, bidirectional communications are often required due to their service features to be provided. It is thought that realizing the bidirectional communications with one optical fiber has various advantages.

One of the conventional construction examples of the bidirectional optical modules providing the bidirectional communications with one optical fiber is shown in FIG. 17 (see Patent Document 1 below). In the construction shown in FIG. 17, a light receiver 63 and a light transmitter 64 are connected with an optical connector 61 through the intermediary of an optical fiber coupler 62. All or part of receiver signal lights entering from the optical connector 61 enter the light receiver 63 through an optical fiber α65, the optical fiber coupler 62 and an optical fiber β66. All or part of transmitter signal lights emitted by the light transmitter 64 are emitted by the optical connector 61 through an optical fiber γ67, the optical fiber coupler 62 and the optical fiber a 65.

[Patent Document 1]

Japanese Patent Laid-Open Publication No. H11-284576 (paragraphs 0007 to 0011 and FIG. 1)

In the FTTH, it is thinkable that a bidirectional data communications service and a broadcasting image distribution service are provided by using wavelength division multiplexing with one optical fiber. In this case, a user side needs an optical drop module when receiving provision of the image distribution service.

One of the conventional construction examples of the optical drop modules is, as shown in FIG. 18, a case, wherein a light receiver (general PD module) is connected with a wavelength dispersive circuit (general WDM module) having three optical fiber ends through the intermediary of an optical fiber. As a general WDM module, for example, WDM coupler shown in Nonpatent Document 1 is known. That is, in the construction shown in FIG. 18, a light receiver 74 is connected through the intermediary of a single wavelength dispersive circuit 73 between an optical connector ≢71 and an optical connector β72. Signal lights entering from the optical connector α71 pass through the optical fiber α65. Wavelengths of part of the signal lights are dispersed at the wavelength dispersive circuit 73. These signal lights enter the light receiver 74 through the optical fiber γ67. Other signal lights are outputted from the optical connector β72 through the optical fiber β66. Signal lights entering from the optical connector β72 pass through the optical fiber β66. After that, all or part thereof pass through the wavelength dispersive circuit 73, and then, are outputted from the optical connector α71 through the optical fiber α65.

[Nonpatent Document 1]

http://www.toyoden.co.jp/prod/hikari/wdm.html. (searched on Nov. 20, 2003)

In the foregoing conventional bidirectional optical module, construction can be easily made by using the optical fiber coupler 62, an existing optical part. However, there has been a problem that lowering cost of the bidirectional optical module is difficult since the optical fiber coupler 62 is generally expensive, and there are three excess parts of the optical fiber to be disposed.

Further, in the foregoing conventional optical drop module, construction can be easily made by using the wavelength dispersive circuit 73, an existing optical part. However, there has been a problem that lowering cost of the optical drop module is difficult since the single wavelength dispersive circuit 73 is generally expensive, and there are three excess parts of the optical fiber to be disposed.

### SUMMARY OF THE INVENTION

In light of the foregoing, it is a first object of the invention to provide a bidirectional optical module with small number of its parts and low cost, and an optical transmission devise using it.

In light of the foregoing, it is a second object of the invention to provide an optical drop module with small number of its parts and low cost, and an optical transmission devise using it.

In order to achieve the first object, the bidirectional optical module according to the invention comprises a light receiver, wherein a photo acceptance unit is optically coupled with a light output part obtained by cutting an optical fiber in the middle thereof aslant an optical fiber core, and inserting a filter or a half mirror between obtained cross sections of the core, and a light transmitter, wherein a light emitting device is optically coupled with one end of the optical fiber. The light receiver has a receptacle structure which has a ferrule in which the other end of the optical fiber is inserted from inside, and which can physically contact with an optical connector. Due to this construction, an optical fiber coupler is not used, and further the light receiver has the receptacle structure. Therefore, the bidirectional optical module can be realized with small number of parts compared with in conventional cases, and excess parts of the optical fiber to be disposed can be reduced to only one part.

Further, the bidirectional optical module according to the invention comprises a light receiver, wherein a photo acceptance unit is optically connected with a light output part obtained by partly forming a cutting part to expose part of a lateral face of an optical fiber in a ferrule having a through-hole to insert the optical fiber, letting the optical fiber through the ferrule, forming a slit at the cutting part, forming cross sections aslant a core of the optical fiber, and inserting a filter or a half mirror between the cross sections of the core, and a light transmitter, wherein a light emitting device is optically coupled with one end of the optical fiber. A part protruding from an end face of the ferrule on the other end of the optical fiber is cut, an end face of the ferrule on the side opposite of the light transmitter-connected side is polished to allow the ferrule to physically contact with an optical connector, and the light receiver is set to have a receptacle structure. Due to this construction, the optical fiber coupler is not used, and further the light receiver has the receptacle structure. Therefore, the bidirectional optical module can be realized with small number of parts compared with in conventional cases, and excess parts of the optical fiber to be disposed can be reduced to only one part.

Further, the bidirectional optical module of the invention has a construction, wherein the photo acceptance unit of the light receiver is mounted on the same slave substrate as a subsequent circuit is, and the slave substrate and a master substrate on which the module is mounted are electrically connected by a flexible wiring substrate. Due to this construction, destruction of the light receiver when inserting or ejecting the optical connector can be prevented. In addition, workability when building into the device can be improved.

Further, the bidirectional optical module of the invention has a construction, wherein the slave substrate is a three-dimensional substrate. Due to this construction, design freedom in mounting a preamplifier, connecting the flexible wiring substrate, and further in fixing method for an optical fiber coating is improved. Therefore, the light receiver can be downsized.

Further, the bidirectional optical module of the invention has a construction, wherein the three-dimensional substrate has a shape to engage with a locking piece of an optical connector adapter. Due to this construction, the number of its parts is further reduced.

Further, the bidirectional optical module of the invention has a construction, wherein an index matching resin which is cured by ultraviolet is filled on a light path from the light output part to the photo acceptance unit, and the ferrule is made of a material transparent to the ultra violet which cures the index matching resin. Due to this construction, the slave substrate can be fixed by the ultraviolet curing.

Further, the bidirectional optical module of the invention comprises a light receiver, wherein a photo acceptance unit is optically coupled with a light output part obtained by facing a slope of a first optical fiber whose at least one end is a slope and a slope of a second optical fiber whose at least one end is a slope so that they are optically coupled, and inserting a filter or a half mirror in the both facing slopes of an optical fiber core, and a light transmitter, wherein a light emitting device is optically coupled with an end of the second optical fiber on the side opposite of the light output part. A ferrule which has a through-hole to insert the optical fiber at an end of the first optical fiber at the side opposite of the light output part and which can physically contact with an optical connector is provided, the ferrule and the light receiver are integrated, and the light receiver is set to have a receptacle structure. Due to this construction, the optical fiber coupler is not used, and further the light receiver has the receptacle structure. Therefore, the bidirectional optical module can be realized with small number of parts compared with in conventional cases, and excess parts of the optical fiber to be disposed can be reduced to only one part.

Further, the bidirectional optical module of the invention comprises a light receiver, wherein a photo acceptance unit is optically coupled with a light output part obtained by forming a cutting flat part to expose part of a lateral face of a first optical fiber on one end side of a first ferrule having a through-hole to insert the first optical fiber, letting through the first optical fiber, cutting parts protruding from both ends of the first ferrule, forming a cutting flat part to expose part of a lateral face of a second optical fiber on one end side of a second ferrule having a through-hole to insert the second fiber, letting through the second optical fiber, cutting only a part protruding from the cutting flat part side of the second ferrule, processing the respective optical fiber end faces of the first and the second optical fibers on their cutting flat part sides in the shape of a slope at an angle that the first optical fiber and the second optical fiber are optically coupled when the cutting flat parts of the first ferrule and the second ferrule are faced so that they are on the same level, facing the cutting flat part sides of the first ferrule and the second ferrule are faced so that they are on the same level, and inserting a filter or a half mirror between the both slopes of an optical fiber core; and a light transmitter, wherein a light emitting device is optically coupled with an end of the second optical fiber on the side opposite of the light output part. An end face of the first ferrule on the side opposite of the cutting flat part is polished to allow the ferrule to physical contact with an optical connector, and the light receiver has a receptacle structure. Due to this construction, the optical fiber coupler is not used, and further, the light receiver has a receptacle structure. Therefore, the bidirectional optical module can be realized with small number of parts compared with in conventional cases, and excess part of the optical fiber to be disposed can be reduced to only one part.

Further, the bidirectional optical module constructing the light receiver by using the foregoing two ferrules has a construction, wherein the photo acceptance unit is mounted on the same slave substrate as a subsequent circuit is, and the slave substrate and a master substrate on which the module is mounted are electrically connected by a flexible wiring substrate. Due to this construction, destruction of the light receiver when inserting or ejecting the optical connector can be prevented. In addition, workability when building into the device can be improved.

Further, the optical transmission device of the invention has a construction, wherein the foregoing bidirectional optical module is mounted. Due to this construction, cost for manufacturing the device can be lowered.

In order to achieve the foregoing second object, the optical drop module comprises a light receiver, wherein a photo acceptance unit is optically coupled with a light output part obtained by cutting an optical fiber in the middle thereof aslant a core of the optical fiber, and inserting a filter between obtained cross sections of the core. An optical connector is provided at one end of the optical fiber, a ferrule which can physically contact with an optical connector is provided on the other end of the optical fiber, the ferrule and the light receiver are integrated, and the light receiver is set to have a receptacle structure. Due to this construction, a single wavelength dispersive circuit is not used, and further the light receiver has a receptacle structure. Therefore, the optical drop module can be realized with a small number of parts compared with in conventional cases, and excess parts of the optical fiber can be reduced to only one part.

Further, the optical drop module of the invention comprises a light receiver, wherein a photo acceptance unit is optically coupled with a light output part obtained by partly forming a cutting part to expose part of a lateral face of an optical fiber in a ferrule having a through-hole to insert the optical fiber, letting the optical fiber through the ferrule, forming a slit at the cutting part, forming cross sections aslant a core of the optical fiber, and inserting a filter between the cross sections of the core. An optical connector is provided at one end of the optical fiber, a part protruding from an end face of the ferrule on the other end side of the optical fiber is cut, an end face of the ferrule on the side opposite of the optical connector-provided side is polished to allow the ferrule to physically contact with an optical connector, and the light receiver is set to have a receptacle structure. Due to this construction, the single wavelength dispersive circuit is not used, and further the light receiver has a receptacle structure. Therefore, the optical drop module can be realized with small number of parts compared with in conventional cases. In addition, excess parts of the optical fiber to be disposed can be reduced to only one part.

Further, the optical drop module of the invention has a construction, wherein the photo acceptance unit of the light receiver is mounted on the same slave substrate as a subsequent circuit is, and the slave substrate and a master substrate on which the module is mounted are electrically connected by a flexible wiring substrate. Due to this construction, destruction of the light receiver when inserting or ejecting the optical connector can be prevented, and workability when building into the device can be improved.

Further, the optical drop module of the invention has a construction, wherein the slave substrate is a three-dimensional substrate. Due to this construction, design freedom in mounting a preamplifier, connecting the flexible wiring substrate, and further fixing method for an optical fiber coating is improved. Therefore, the light receiver can be downsized.

Further, the optical drop module of the invention has a construction, wherein the three-dimensional substrate has a shape to engage with a locking piece of an optical connector adapter. Due to this construction, the number of its parts is further reduced.

Further the optical drop module of the invention has a construction, wherein an index matching resin which is cured by ultraviolet is filled on a light path from the light output part to the photo acceptance unit, and the ferrule is made of a material transparent to the ultraviolet which cures the index matching resin. Due to this construction, the slave substrate can be fixed by the ultraviolet curing.

Further, the optical drop module of the invention comprises a light receiver, wherein a photo acceptance unit is optically coupled with a light output part obtained by facing a slope of a first optical fiber whose at least one end is a slope and a slope of a second optical fiber whose at least one end is a slope so that they are optically coupled, and inserting a filter between the facing both slopes of the core. An optical connector is provided at an end of the second optical fiber on the side opposite of the light output part, a ferrule which has a through-hole to insert the optical fiber and which can physically contact with an optical connector is provided at an end of the first optical fiber on the side opposite of the light output part, the ferrule and the light receiver are integrated, and the light receiver is set to have a receptacle structure. Due to this construction, the single wavelength dispersive circuit is not used, and further the light receiver has a receptacle structure. Therefore, the optical drop module can be realized with small number of parts compared with in conventional cases, and excess parts of the optical fiber to be disposed can be reduced to only one part.

Further, the optical drop module of the invention comprises a light receiver, wherein a photo acceptance unit is optically coupled with a light output part obtained by forming a cutting flat part to expose part of a lateral face of a first optical fiber on one end side of a first ferrule having a through-hole to insert the first optical fiber, letting through the first optical fiber, cutting parts protruding from both ends of the first ferrule, forming a cutting flat part to expose part of a lateral face of a second optical fiber on one end side of a second ferrule having a through-hole to insert the second fiber, letting through the second optical fiber, cutting only a part protruding from the cutting flat part side of the second ferrule, processing respective optical fiber end faces of the first and the second optical fibers on their cutting flat part sides in the shape of a slope at an angle that the first optical fiber and the second optical fiber are optically coupled when the cutting flat parts of the first ferrule and the second ferrule are faced so that they are on the same level, facing the cutting flat part sides of the first ferrule and the second ferrule so that they are on the same level, and inserting a filter between the both slopes of an optical fiber core. An optical connector is provided at an end of the second optical fiber on the side opposite of the light output part, an end face of the first ferrule on the side opposite of the cutting flat part is polished to allow the ferrule to physically contact with an optical connector, and the light receiver has a receptacle structure. Due to this construction, the single wavelength dispersive circuit is not used, and further, the light receiver has a receptacle structure. Therefore, the optical drop module can be realized with small number of parts compared with in conventional cases, and excess parts of the optical fiber to be disposed can be reduced to only one part.

Further, the foregoing bidirectional optical module constructing a light receiver by using two ferrules has a construction, wherein the photo acceptance unit is mounted on the same slave substrate as a subsequent circuit is, and the slave substrate and a master substrate on which the module is mounted are electrically connected by a flexible wiring substrate. Due to this construction, destruction of the light receiver when inserting or ejecting an optical connector can be prevented, and workability when building into the device can be improved.

Further, the optical transmission device of the invention has a construction, wherein the foregoing optical drop module is mounted. Due to this construction cost for manufacturing the device can be lowered.

### BRIEF DESCRIPTION OF THE DRAWINGS

FIG. 1A is a constructional figure of a bidirectional optical module in a first embodiment of the invention;

FIG. 1B is a figure which describes a manufacturing procedure for a part (light output part) to output receiver signal lights from an optical fiber in a light receiver of FIG. 1A;

FIG. 1C is a figure which illustrates a view that the light receiver is constructed by optically coupling a photo acceptance unit with the light output part of FIG. 1A;

FIG. 2A is a constructional figure of a bidirectional optical module in a second embodiment of the invention;

FIG. 2B is a figure to further describe a construction of a light receiver of FIG. 2A;

FIG. 3 is a cross sectional view which describes a construction of the bidirectional optical module in the second embodiment of the invention;

FIG. 4A is a constructional figure of a bidirectional optical module in a third embodiment of the invention;

FIG. 4B is an enlarged view of a light receiver of FIG. 4A;

FIG. 5 is a cross sectional view which describes a construction of the bidirectional optical module in the third embodiment of the invention;

FIG. 6A is a constructional figure of a bidirectional optical module in a fourth embodiment of the invention;

FIG. 6B is a figure which describes a manufacturing procedure for a part (light output part) to output receiver signal lights from an optical fiber in a light receiver of FIG. 6A;

FIG. 6C is a figure which illustrates a view that the light receiver is constructed by optically coupling a photo acceptance unit with the light output part of FIG. 6A;

FIG. 7A is a constructional figure of a bidirectional optical module in a fifth embodiment of the invention;

FIG. 7B is a figure to describe a construction of a light receiver of FIG. 7A;

FIG. 8 is a cross sectional view which describes a construction of the bidirectional optical module in the fifth embodiment of the invention;

FIG. 9A is a constructional figure of an optical drop module in a sixth embodiment of the invention;

FIG. 9B is a figure which describes a manufacturing procedure for part of FIG. 9A;

FIG. 9C is a figure which describes a manufacturing procedure for part of FIG. 9A;

FIG. 10 is a constructional figure of an optical drop module in a seventh embodiment of the invention;

FIG. 11A is a constructional figure of a light receiver in the optical drop module in the seventh embodiment of the invention;

FIG. 11B is a cross sectional view which describes a construction of part of FIG. 1A in detail;

FIG. 12 is a constructional figure of an optical drop module in an eighth embodiment of the invention;

FIG. 13A is a constructional figure of a light receiver in the optical drop module in the eighth embodiment of the invention;

FIG. 13B is a cross sectional view which describes a construction of FIG. 13A in detail;

FIG. 14A is a constructional figure of an optical drop module in a ninth embodiment of the invention;

FIG. 14B is a figure which describes a manufacturing procedure for part of FIG. 12A;

FIG. 14C is a figure which describes a manufacturing procedure for part of FIG. 12A;

FIG. 15 is a constructional figure of an optical drop module in a tenth embodiment of the invention;

FIG. 16A is a constructional figure of a light receiver in the optical drop module in the tenth embodiment of the invention;

FIG. 16B is a cross sectional view which describes a construction of part of FIG. 15 in detail;

FIG. 17 is a constructional figure of a conventional bidirectional optical module; and

FIG. 18 is a constructional figure of a conventional optical drop module.

### DESCRIPTION OF THE PREFERRED EMBODIMENTS

Embodiments of the invention will be described hereinbelow with reference to the drawings.

[First Embodiment]

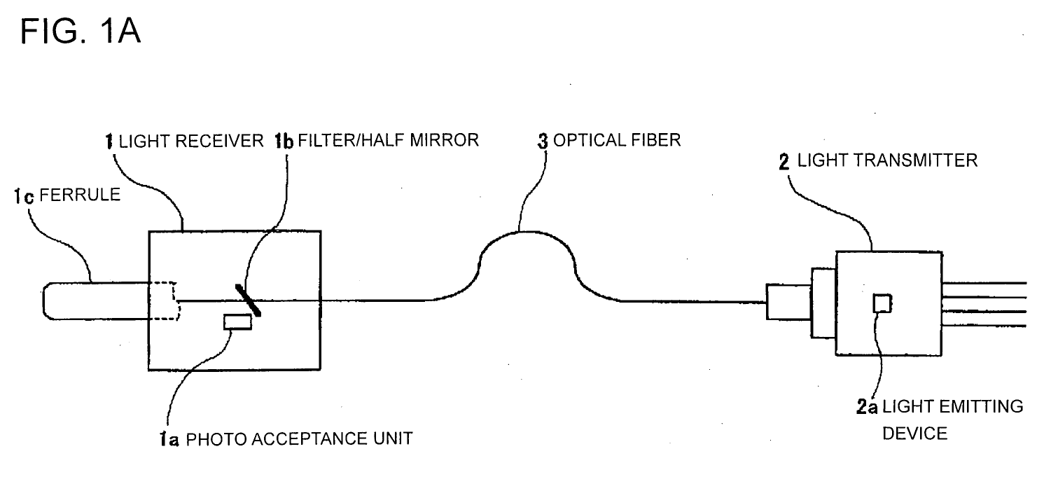

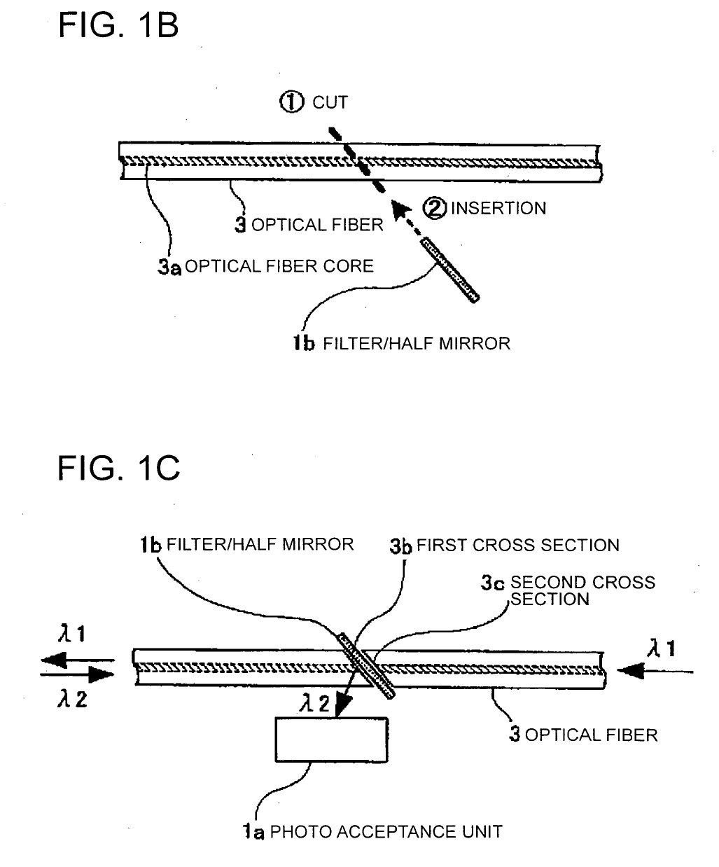

FIGS. 1A, 1B, and IC are figures which describe a bidirectional optical module according to a first embodiment of the invention. FIG. 1A shows a constructional figure of the bidirectional optical module. A light receiver 1 has a receptacle structure which includes a ferrule Ic available to physically contact with an optical connector (not shown).

Inside of the ferrule 1c, there is a through-hole (not shown) to insert an optical fiber 3. The optical fiber 3 is inserted in the through-hole. Part or all of receiver signal lights entering from the ferrule 1c are reflected by a filter/half mirror 1b which is inserted in the middle of the optical fiber 3, are outputted from the optical fiber 3, and enter a photo acceptance unit 1a in the light receiver 1. A light transmitter 2 is constructed so that transmitter signal lights emitted by a light emitting device 2a enter the optical fiber 3. Part or all of the transmitter signal lights emitted by the light transmitter 2 pass inside of the light receiver 1 through the optical fiber 3, and are emitted by the ferrule 1c.

FIGS. 1B and 1C are figures which describe a manufacturing procedure for a part (light output part) to output the receiver signal lights from the optical fiber 3 in the light receiver 1 of FIG. 1A. As shown in FIGS. 1B and 1C, this light output part is obtained by, firstly cutting the optical fiber 3 in the middle thereof aslant an optical fiber core 3a, and then inserting the filter/half mirror 1b between a first cross section 3b and a second cross section 3c of the core.

FIG. 1C is a figure which illustrates a view that the light receiver 1 is constructed by further optically coupling the photo acceptance unit 1a with the light output part of FIG. 1A. In this figure, receiver signal lights of wavelength λ2 enter from the left side of the figure. Part or all thereof are reflected by the filter/half mirror 1b, and enter the photo acceptance unit 1a. Transmitter signal lights of wavelength λ1 enter from the right side of the figure. Part or all thereof pass through the filter/half mirror 1b, and are emitted from the left side. In the case that the wavelength λ1 and the wavelength λ2 are different wavelengths, the filter is applied. In the case that the wavelength λ1 and the wavelength λ2 are the same wavelength, the half mirror is applied.

Due to such a construction, in the bidirectional optical module according to the first embodiment of the invention, an optical fiber coupler is not used. In addition, the light receiver 1 has a receptacle structure. Therefore, the bidirectional optical module can be realized with small number of parts compared with in conventional examples. Further, excess parts of the optical fiber to be disposed can be reduced to only one part. Consequently, cost reduction can be realized.

[Second Embodiment]

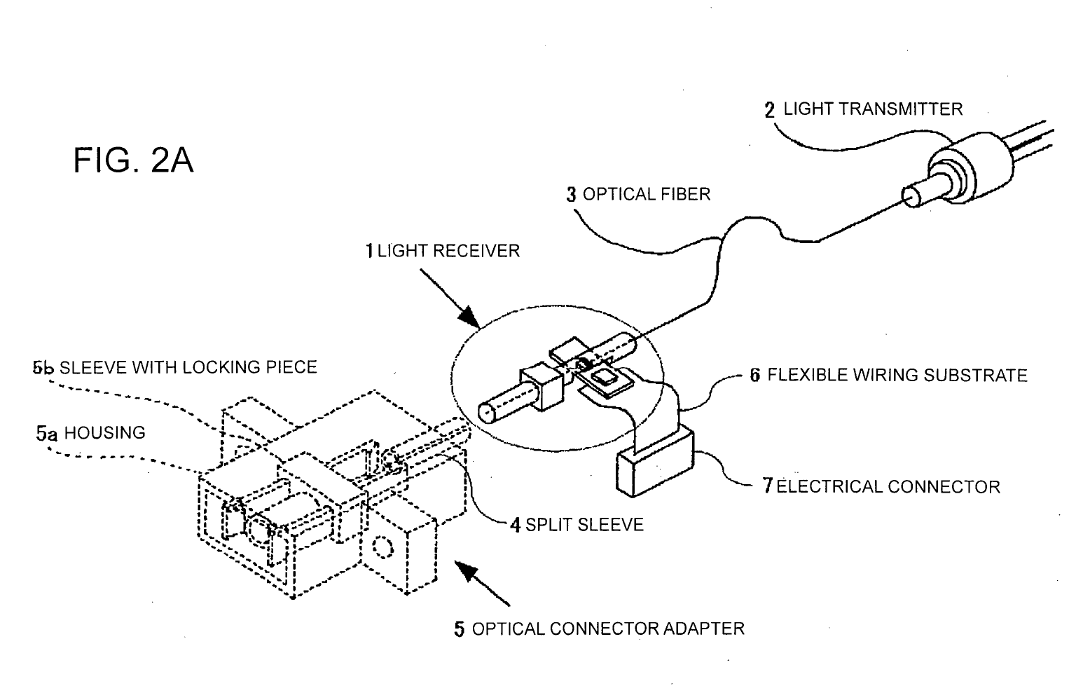

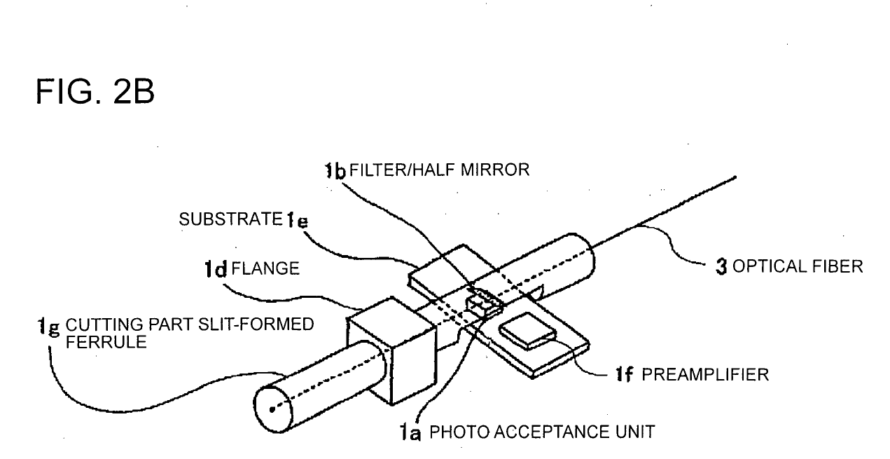

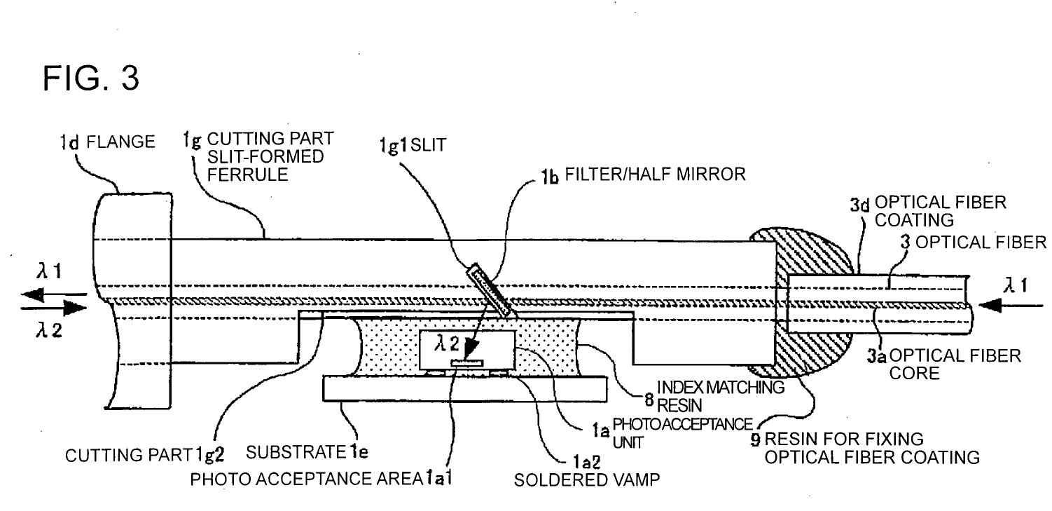

FIGS. 2A, 2B, and 3 are figures which describe a bidirectional optical module according to a second embodiment of the invention. FIG. 2A shows a constructional figure of the bidirectional optical module. The second embodiment shown in this FIG. 2A is one example which shows more specific construction of the light receiver 1 according to the foregoing first embodiment. In this construction, the light receiver 1 is connected with a master substrate on which the module is mounted through the intermediary of a flexible wiring substrate 6 and an electrical connector 7. In FIG. 2A, a split sleeve 4 and an optical connector adapter 5 are shown, and a housing 5a and a sleeve with locking piece 5b thereof are shown.

FIG. 2B is a figure to further describe a construction of this light receiver 1. FIG. 3 is a cross sectional view which describes in detail a structure in the vicinity of a light output part. As shown in FIG. 3, a cutting part 1g2 to expose part of a lateral face of the optical fiber 3 is partly formed in a ferrule having a through-hole to insert the optical fiber 3. After the optical fiber 3 is let through a ferrule 1g, a slit 1g1 is formed at the cutting part 1g2 to form cross sections aslant the core 3a of the optical fiber 3. Then, the filter/half mirror 1b is inserted between the cross sections of the core. The light output part obtained thereby is optically coupled with the photo acceptance unit 1a. The ferrule, wherein the cutting part 1g2 and the slit 1g1 are formed is called a cutting part slit-formed ferrule (or simply ferrule) 1g. In FIG. 3, the photo acceptance unit 1a is provided over a substrate 1e through the intermediary of a soldered vamp 1a2. A photo acceptance area in the photo acceptance unit 1a is shown as a symbol, 1a1.

A part which protrudes from an end face of the ferrule lg on the other end side of the optical fiber 3 is cut. An end face of the ferrule 1g on the side opposite of the light transmitter 2-connected side is polished to allow the ferrule to physically contact with the optical connector. The light receiver 1 has a receptacle structure.

A resin which matches index with the optical fiber (index matching resin) 8 is filled between the light output part and the photo acceptance unit 1a. An optical fiber coating 3d is fixed on the ferrule Ig by a resin for fixing optical fiber coating 9. A flange 1d is installed on the cutting part slit-formed ferrule 1g, in order to engage with a locking piece of the sleeve with locking piece 5b of the optical connector adapter 5. The ferrule is connected with the optical connector through the intermediary of the split sleeve 4.

Due to this construction, in the bidirectional optical module according to the second embodiment of the invention, the optical fiber coupler is not used. In addition, the light receiver 1 has a receptacle structure. Therefore, the bidirectional optical module can be realized with small number of parts compared with in conventional examples. Further, excess parts of the optical fiber to be disposed can be reduced to only one part. Consequently, cost reduction can be realized.

Further, the photo acceptance unit 1a is mounted on the same slave substrate 1e as a preamplifier 1f as a subsequent circuit is, and the slave substrate 1e and a master substrate on which the module is mounted are electrically connected by the flexible wiring substrate 6. Therefore, destruction of the light receiver 1 when inserting or ejecting the optical connector can be prevented, and workability when building into the device can be improved. Furthermore, the index matching resin 8 is set to UV cure type, and the ferrule 1g is set to a material transparent to ultraviolet which cures the index matching resin 8. Therefore, the slave substrate 1e can be fixed by ultraviolet curing.

[Third Embodiment]

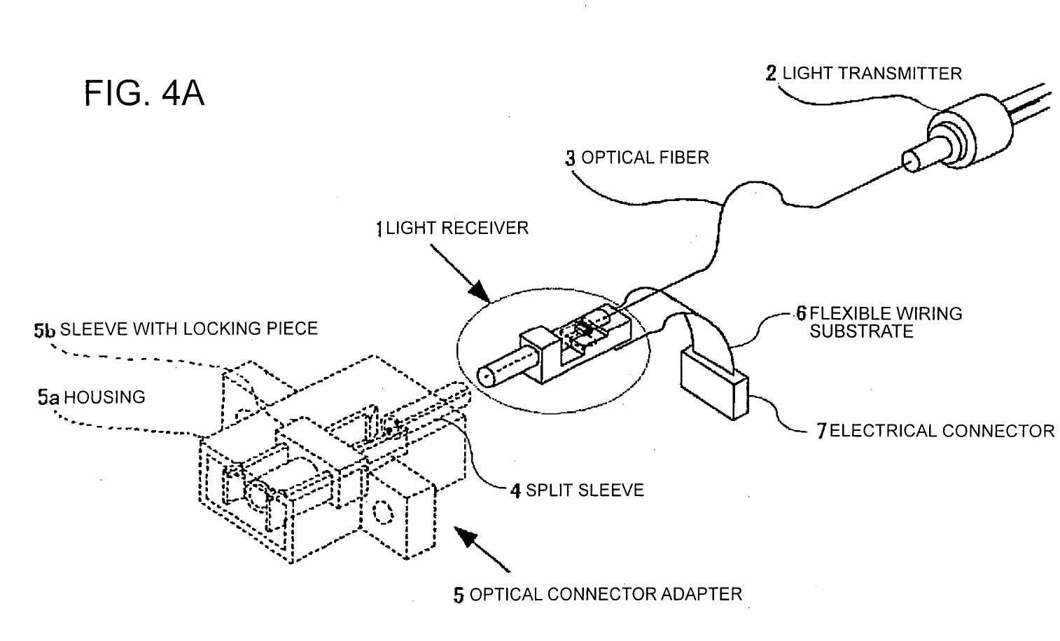

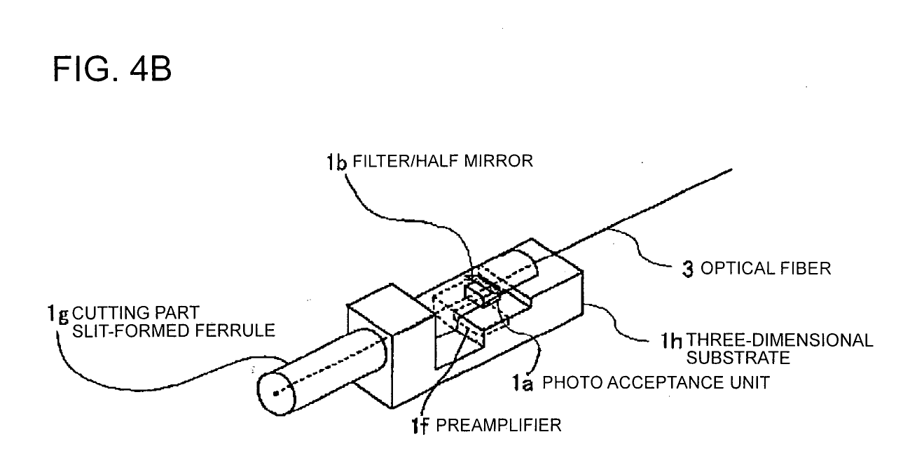

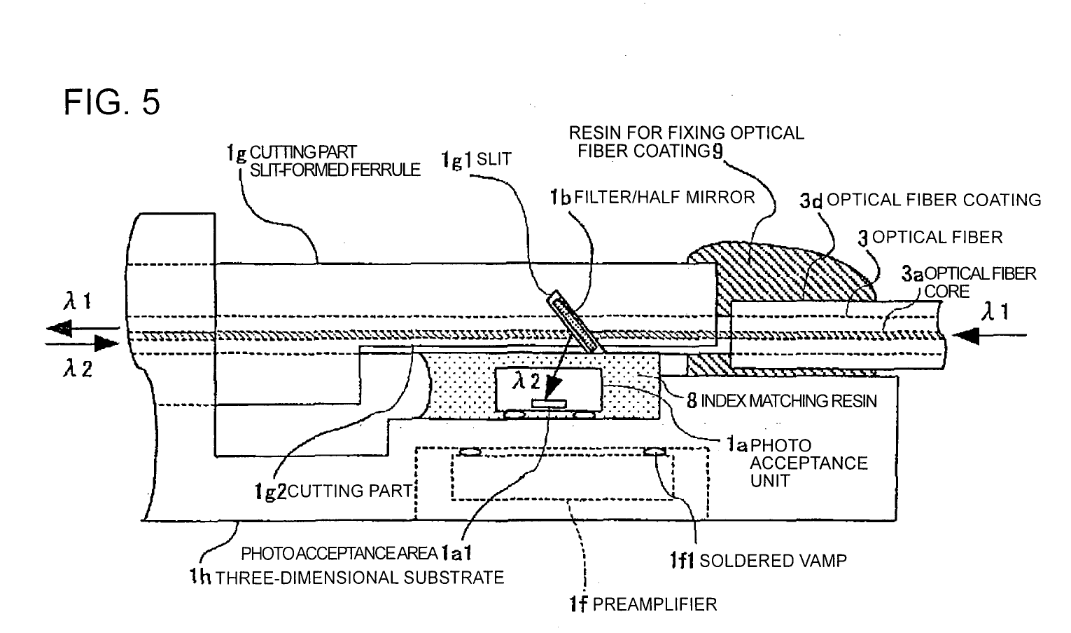

FIGS. 4A, 4B, and FIG. 5 are figures which describe a bidirectional optical module according to a third embodiment of the invention. FIG. 4A shows a constructional figure of the bidirectional optical module. The third embodiment of this FIG. 4A is another example which shows more specific construction of the light receiver 1 of the foregoing first embodiment. One of the differences from the foregoing second embodiment is, as shown in detail in FIG. 4B, a slave substrate on which the photo acceptance unit 1a and the preamplifier 1f as a subsequent circuit are mounted is a three-dimensional substrate 1h.

By setting the slave substrate to the three-dimensional substrate 1h as above, as shown in detail in FIG. 5, design freedom in mounting the preamplifier 1f, connecting the flexible wiring substrate 6, and further fixing method of the optical fiber coating 3d is improved. Therefore, the light receiver 1 can be downsized. Another advantage of this embodiment is that the flange 1d required for the foregoing second embodiment becomes unnecessary by making the three-dimensional substrate 1h in the shape available to engage with a locking piece of the sleeve with locking piece 5b of the optical connector adapter 5.

[Fourth Embodiment]

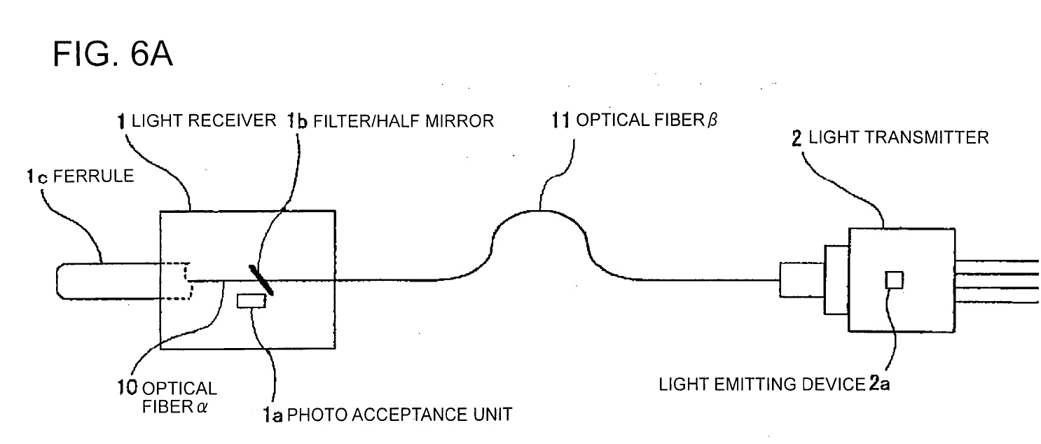

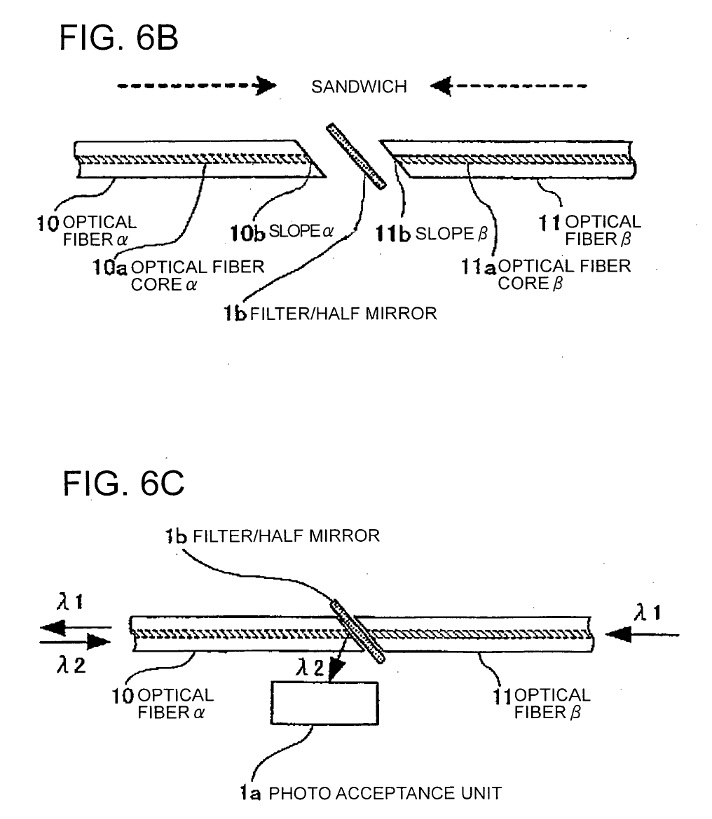

FIGS. 6A, 6B, and 6C are figures which describe a bidirectional optical module according to a fourth embodiment of the invention. FIG. 6A shows a constructional figure of the bidirectional optical module. The light receiver 1 has a receptacle structure which includes the ferrule 1c available to physically contact with the optical connector. The ferrule 1c includes a through-hole (not shown) to insert an optical fiber α10. The optical fiber α10 is inserted in the through-hole from inside. Part or all of receiver signal lights entering from the ferrule 1c are reflected by the filter/half mirror 1b which is sandwiched between the optical fiber α10 and an optical fiber β11. These lights are outputted from the optical fiber α10, and enter the photo acceptance unit 1a in the light receiver 1.

The light transmitter 2 is constructed so that transmitter signal lights emitted by the light emitting device 2a enter the optical fiber β11. Part or all of the transmitter signal lights emitted by the light transmitter 2 pass inside of the light receiver 1 through the optical fiber β11 and the optical fiber α10, and are emitted by the ferrule 1c.

FIGS. 6B and 6C are figures which describe a manufacturing procedure for a part (light output part) to output the receiver signal lights from the optical fiber α10 in the light receiver 1 of FIG. 6A. As shown in FIG. 6B, this light output part is obtained by facing a slope α10b and a slope β11b so that the first optical fiber α10 including the slope α10b and the second optical fiber β11 including the slope β11b are optically coupled, and inserting the filter/half mirror 1b between the both facing slopes of the core.

FIG. 6C is a figure that the light receiver 1 is constructed by optically coupling the photo acceptance unit 1a with this light output part. In this figure, receiver signal lights of wavelength λ2 enter from the left side. Part or all thereof are reflected by the filter/half mirror 1b, and enter the photo acceptance unit 1a. Transmitter signal lights of wavelength λ1 enter from the right side. Part or all thereof pass through the filter/half mirror 1b, and are emitted from the left side. In the case that the wavelength λ1 and the wavelength λ2 are different wavelengths, the filter is applied. In the case that the wavelength λ1 and the wavelength λ2 are the same wavelength, the half mirror is applied.

Due to this construction, in the bidirectional optical module according to the fourth embodiment of the invention, the optical fiber coupler is not used. In addition, the light receiver 1 has a receptacle structure. Therefore, the bidirectional optical module can be realized with small number of parts compared with in conventional examples. Further, excess parts of the optical fiber to be disposed can be reduced to only one part. Consequently, cost reduction can be realized.

[Fifth Embodiment]

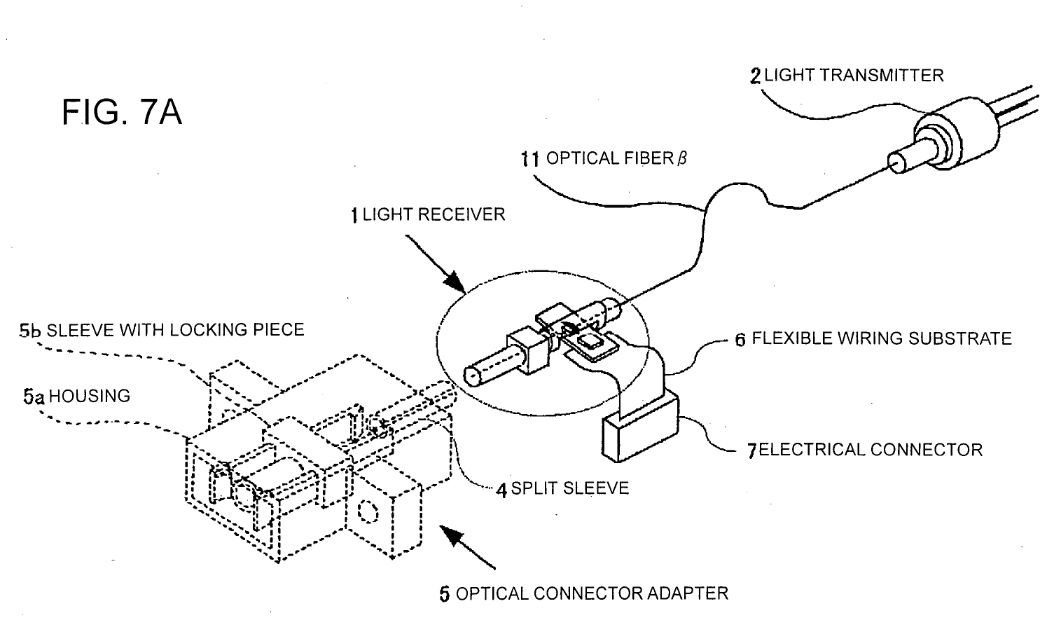

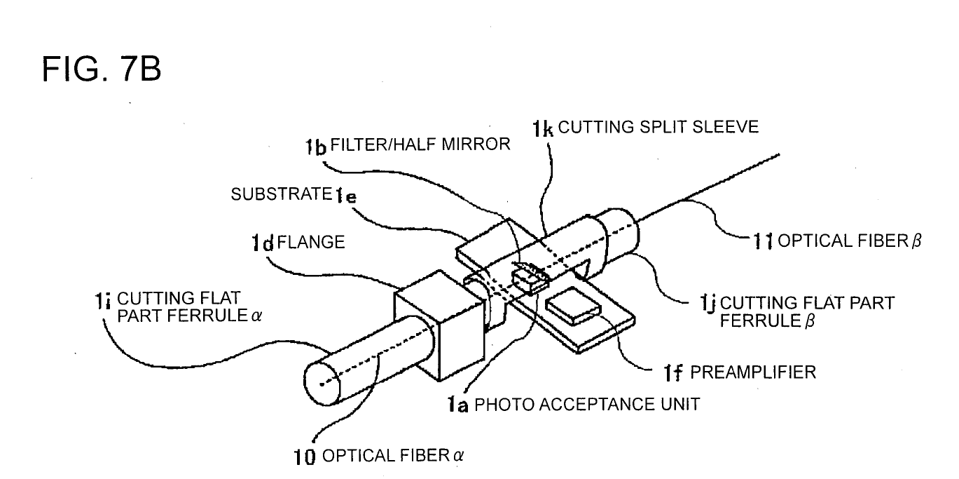

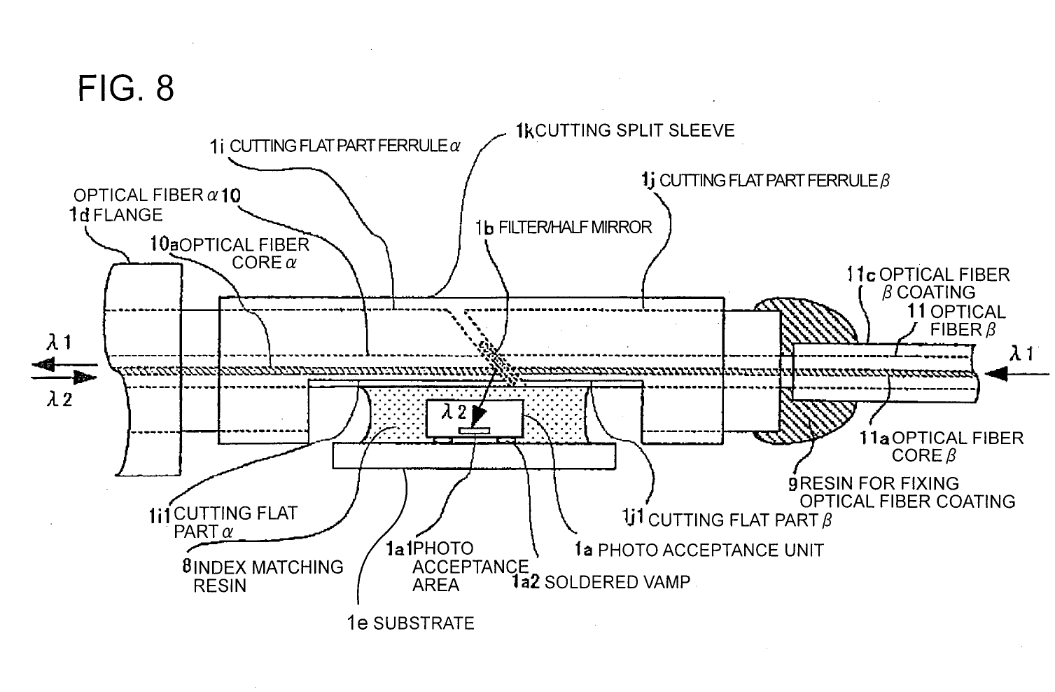

FIGS. 7A, 7B, and 8 are figures which describe a bidirectional optical module according to a fifth embodiment of the invention. FIG. 7A shows a constructional figure of the bidirectional optical module. The fifth embodiment shown in this FIG. 7A is one example which shows more specific construction of the light receiver 1 in the foregoing fourth embodiment. In this construction, the light receiver 1 is connected with a master substrate on which the module is mounted through the intermediary of the flexible wiring substrate 6 and the electrical connector 7.

FIG. 7B is a figure to describe the construction of this light receiver 1. FIG. 8 is a cross sectional view which describes in detail a structure in the vicinity of a light output part. A cutting flat part α1i1 to expose part of a lateral face of the first optical fiber α10 is formed on one end side of a first ferrule α1i having a through-hole to insert the first optical fiber α10. The first optical fiber α10 is let through the first ferrule α1i, and parts thereof protruding from the both ends of the first ferrule α1i are cut. A cutting flat part β1j1 to expose part of a lateral face of the second optical fiber β11 is formed on one end side of a second ferrule β1j having a through-hole to insert the second optical fiber β11. The second optical fiber β11 is let through the second ferrule β1j, and only a part thereof protruding from the cutting flat part β1j1 side of the second ferrule β1j is cut. When the cutting flat part α1i1 of the first ferrule ≢1i and the cutting flat part β1j1 of the second ferrule β1j are faced so that they are on the same level, both optical fiber end faces on respective cutting flat part sides are processed in the shape of a slope at an angle that the first optical fiber α10 and the second optical fiber β11 are optically coupled. Then, the cutting flat part α1i1 of the first ferrule α1i and the cutting flat part β1j1 of the second ferrule β1j are faced so that they are on the same level. After that, the filter/half mirror 1b is inserted between the both slopes of the core. The light output part obtained thereby is optically coupled with the photo acceptance unit 1a. The ferrules α and β, wherein the cutting flat parts α and β are provided are called a cutting flat part ferrule α and a cutting flat part ferrule β respectively.

An end face of the first ferrule α1i on the side opposite of the cutting flat part α1i1 is polished to allow the ferrule to physically contact with the optical connector adapter 5. The light receiver 1 has a receptacle structure.

The resin 8 which matches index with the optical fiber is filled between the light output part and the photo acceptance unit 1a. An optical fiber β coating 11c is fixed on the cutting flat part ferrule β1j by a resin for fixing optical fiber coating 9. The flange 1d is installed on the cutting flat part ferrule α1i, in order to engage with a locking piece of the sleeve with locking piece 5b of the optical connector adapter 5. The cutting flat part ferrule α1i is connected with the optical connector through the intermediary of the split sleeve 4.

Due to this construction, in the bidirectional optical module according to the fifth embodiment of the invention, the optical fiber coupler is not used. In addition, the light receiver 1 has a receptacle structure. Therefore, the bidirectional optical module can be realized with small number of parts compared with in conventional examples, and excess parts of the optical fiber to be disposed can be reduced to only one part. Consequently, cost reduction can be realized.

Further, the photo acceptance unit 1a is mounted on the same slave substrate 1e as the preamplifier 1f as a subsequent circuit is, and the slave substrate 1e and a master substrate on which the module is mounted are electrically connected by the flexible wiring substrate 6. Therefore, destruction of the light receiver 1 when inserting or ejecting the optical connector can be prevented, and workability when building into the device can be improved.

In the foregoing first to fifth embodiments, descriptions have been given of the bidirectional optical module respectively. A low-cost optical transmission device can be constructed by mounting such a bidirectional optical module on the optical transmission device.

[Sixth Embodiment]

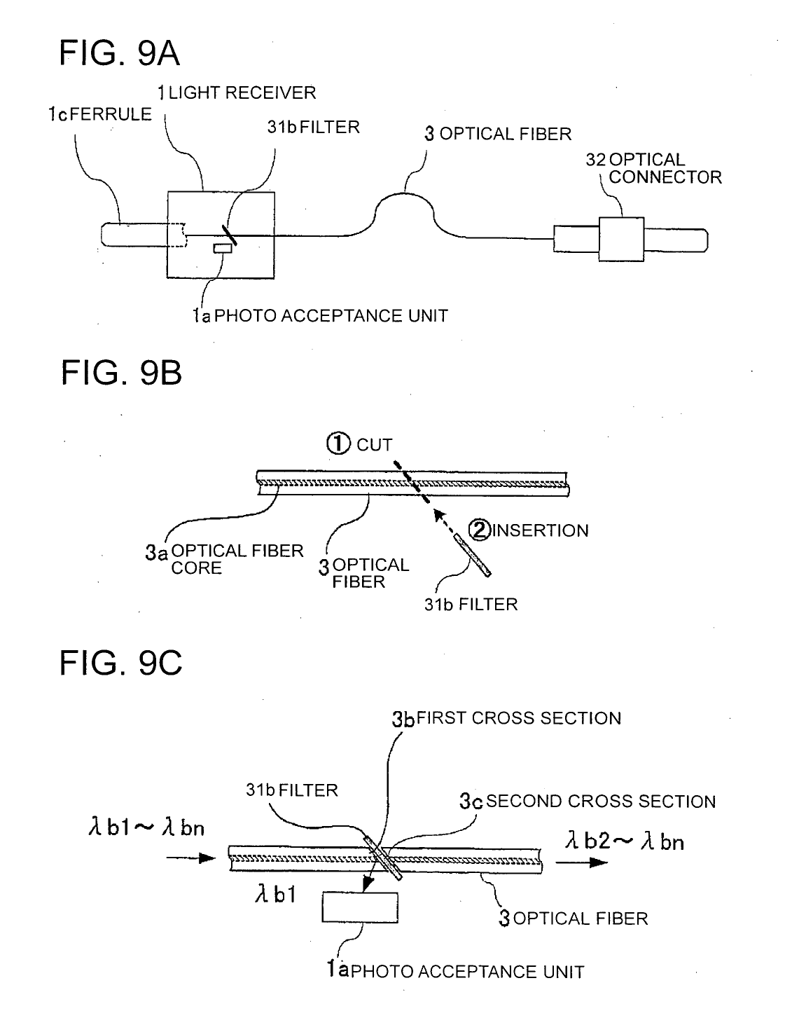

FIGS. 9A, 9B, and 9C are figures which describe an optical drop module according to a sixth embodiment of the invention. FIG. 9A shows a constructional figure of the optical drop module. The light receiver 1 has a receptacle structure which includes the ferrule 1c available to physically contact with an optical connector.

Inside of the ferrule 1c, there is a through-hole (not shown) to insert the optical fiber 3. The optical fiber 3 is inserted in the through-hole. Part or all of signal lights entering from the ferrule 1c are reflected by a filter 31b which is inserted in the middle of the optical fiber 3. These lights are outputted from the optical fiber 3, and enter the photo acceptance unit 1a in the light receiver 1. Part or all of signal lights entering from an optical connector 32 pass inside of the light receiver 1 through the optical fiber 3, and are emitted by the ferrule 1c.

FIGS. 9B and 9C are figures which describe a manufacturing procedure for a part (light output part) to output the receiver signal lights from the optical fiber 3 in the light receiver 1 of FIG. 9A. As shown in FIGS. 9B and 9C, this light output part is obtained by, firstly cutting the optical fiber 3 in the middle thereof aslant the optical fiber core 3a, and then inserting the filter 31b between the first cross section 3b and the second cross section 3c of the core. A half mirror can be used instead of the filter 31b.

FIG. 9C is a figure which illustrates a view that the light receiver is constructed by optically coupling the photo acceptance unit 1a with this light output part. In this figure, signal lights of wavelengths of λb1 to λbn enter from the left side. Only the light of wavelength λb1 is reflected by the filter 31b, and enters the photo acceptance unit 1a.

Due to such a construction, in the optical drop module according to the sixth embodiment of the invention, a single wavelength dispersive circuit is not used. In addition, the light receiver 1 has a receptacle structure. Therefore, the optical drop module can be realized with small number of parts compared with in conventional examples. Further, excess parts of the optical fiber to be disposed can be reduced to only one part. Consequently, cost reduction can be realized.

[Seventh Embodiment]

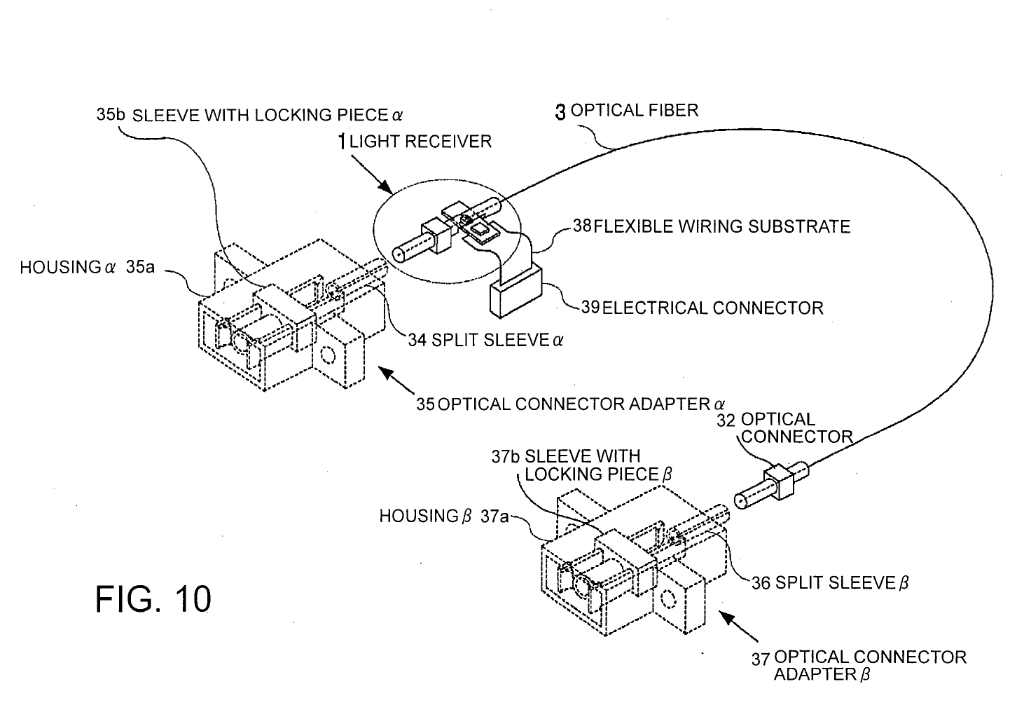

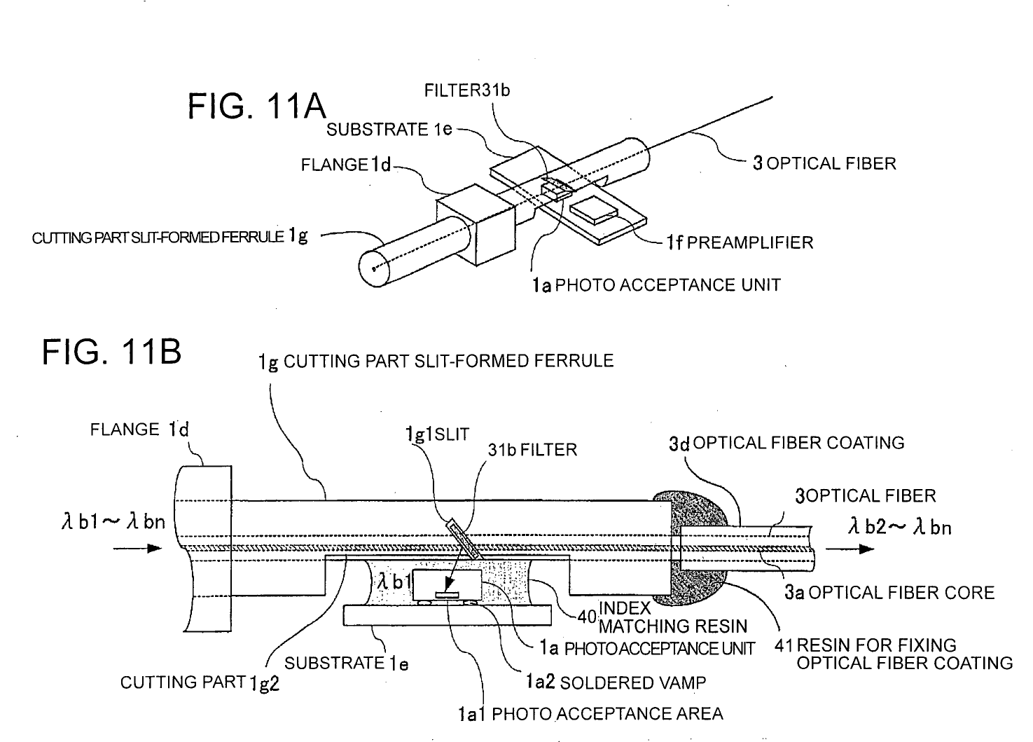

FIGS. 10, 11A, and 11B are figures which describe an optical drop module according to a seventh embodiment of the invention. FIG. 10 shows a constructional figure of the optical drop module. The seventh embodiment shown in this FIG. 10 is one example which shows more specific construction of the light receiver 1 in the foregoing sixth embodiment. In this construction, the light receiver 1 is connected with a master substrate on which the module is mounted through the intermediary of a flexible wiring substrate 38 and an electrical connector 39. In FIG. 10, a split sleeve α and an optical connector adapter α connected with the light receiver 1 are referred to as reference numbers 34 and 35 respectively. A housing α and a sleeve with locking piece α thereof are referred to as reference numbers 35a and 35b respectively. An optical connector adapter β connected with the optical connector 32 is referred to as reference number 37. A housing β, a sleeve with locking piece β, and a split sleeve β thereof are referred to as reference numbers 37a, 37b, and 36 respectively.

FIG. 11A is a figure to describe a construction of this light receiver 1. FIG. 11B is a cross sectional view which further describes in detail a structure in the vicinity of a light output part. As shown in FIGS. 11A and 11B, the cutting part 1g2 to expose part of a lateral face of the optical fiber 3 is partly formed in the cutting part slit-formed ferrule (hereinafter simply referred to as ferrule as well) 1g having a through-hole to insert the optical fiber 3. After the optical fiber 3 is let through the ferrule 1g, the slit 1g1 is formed at the cutting part 1g2 to form cross sections aslant the optical fiber core 3a of the optical fiber 3. Then, the filter 31b is inserted between the cross sections of the core. The light output part obtained thereby is optically coupled with the photo acceptance unit 1a.

A part protruding from an end face of the ferrule 1g on the other end side of the optical fiber 3 is cut. An end face of the ferrule 1g on the side opposite of the optical connector-provided side is polished to allow the ferrule to physically contact with an optical connector. The light receiver 1 has a receptacle structure.

An index matching resin 40 which matches index with the optical fiber is filled between the light output part and the photo acceptance unit 1a. The optical fiber coating 3d is fixed on the ferrule 1g by a resin for fixing optical fiber coating 41. The flange 1d is installed on the cutting part slit-formed ferrule 1g, in order to engage with a locking piece of the sleeve with locking piece α35b of the optical connector adapter α35. The ferrule is connected with the optical connector through the intermediary of the split sleeve α34.

Due to this construction, in the optical drop module according to the seventh embodiment of the invention, the single wavelength dispersive circuit is not used. In addition, the light receiver 1 has a receptacle structure. Therefore, the optical drop module can be realized with small number of parts compared with in conventional examples. Further, excess parts of the optical fiber to be disposed can be reduced to only one part. Consequently, cost reduction can be realized.

Further, the photo acceptance unit 1a is mounted on the same slave substrate 1e as a preamplifier 1f is, and the slave substrate 1e and a master substrate on which the module is mounted are electrically connected by the flexible wiring substrate 38. Therefore, destruction of the light receiver 1 when inserting or ejecting the optical connector can be prevented, and workability when building into the device can be improved. Furthermore, the index matching resin 40 is set to UV cure type, and the ferrule 1g is set to a material transparent to ultraviolet which cures the index matching resin 40. Therefore, the slave substrate 1e can be fixed by ultraviolet curing.

[Eighth Embodiment]

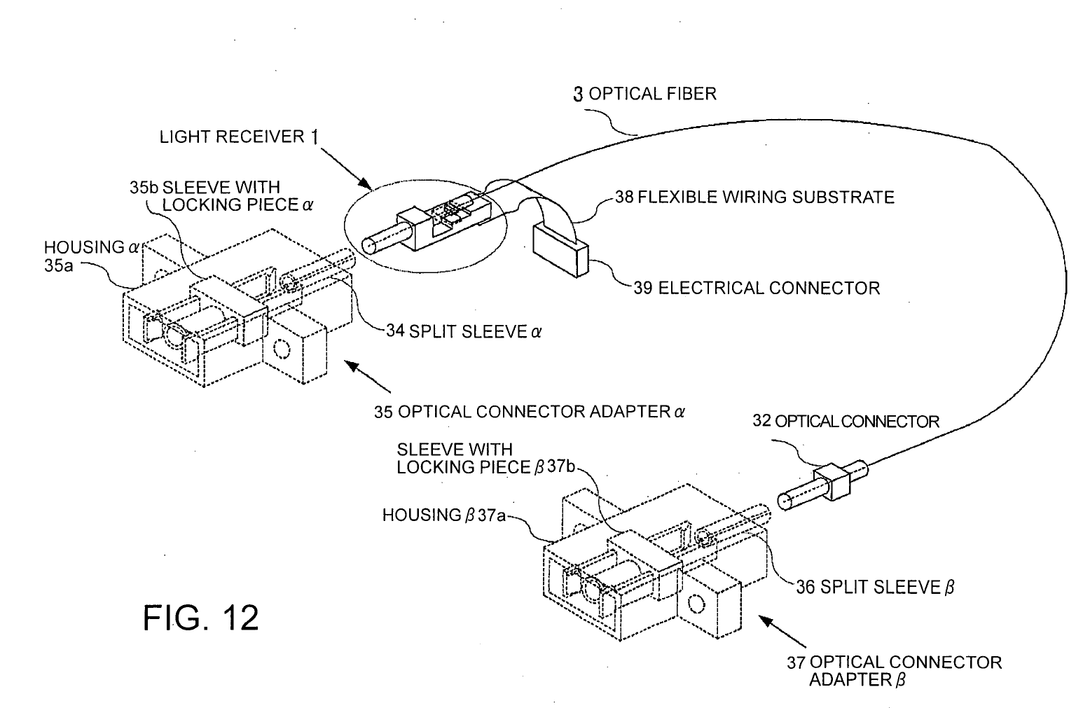

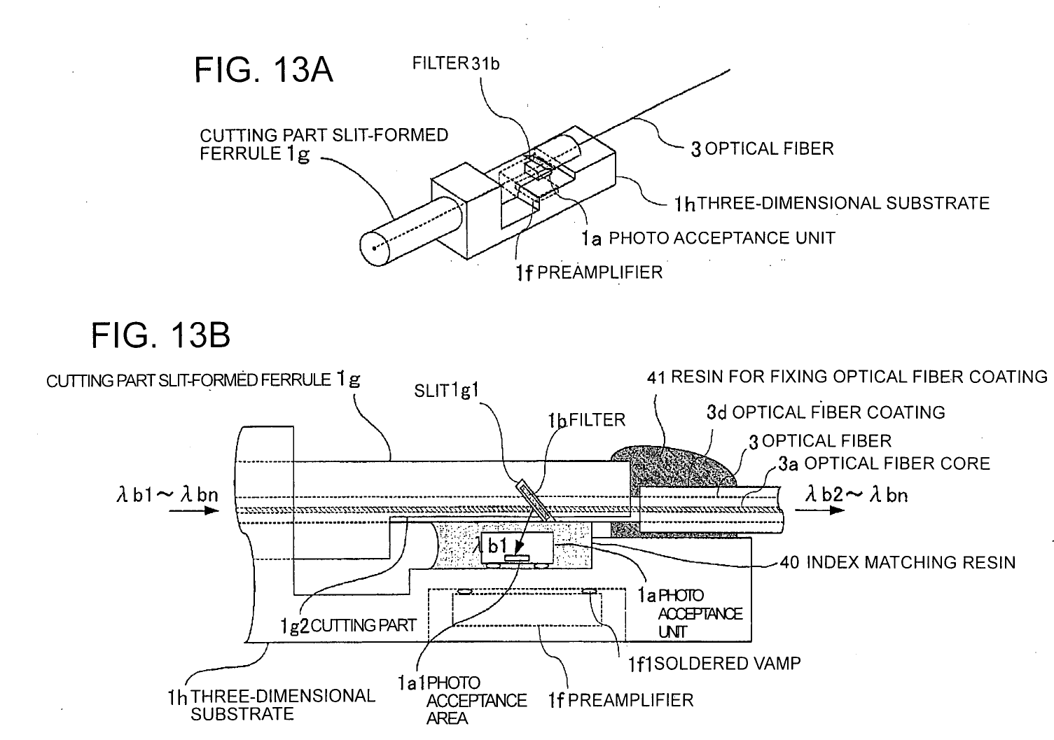

FIGS. 12, 13A, and 13B are figures which describe an optical drop module according to an eighth embodiment of the invention. FIG. 12 shows a constructional figure of the optical drop module. The eighth embodiment shown in this FIG. 12 is another example which shows more specific construction of the light receiver 1 of the foregoing sixth embodiment. One of the differences from the foregoing seventh embodiment is that a slave substrate on which the photo acceptance unit 1a and the preamplifier 1f as a subsequent circuit are mounted is the three-dimensional substrate 1h.

By setting the slave substrate to the three-dimensional substrate 1h as above, as shown in detail in FIGS. 13A and 13B, design freedom in mounting the preamplifier 1f, connecting the flexible wiring substrate, and further fixing method for the optical fiber coating 3d is improved. Therefore, the light receiver 1 can be downsized. In addition, the flange 1d required for the foregoing seventh embodiment becomes unnecessary by making the three-dimensional substrate 1h in the shape available to engage with a locking piece of the sleeve with locking piece α35b of the optical connector adapter α35.

[Ninth Embodiment]

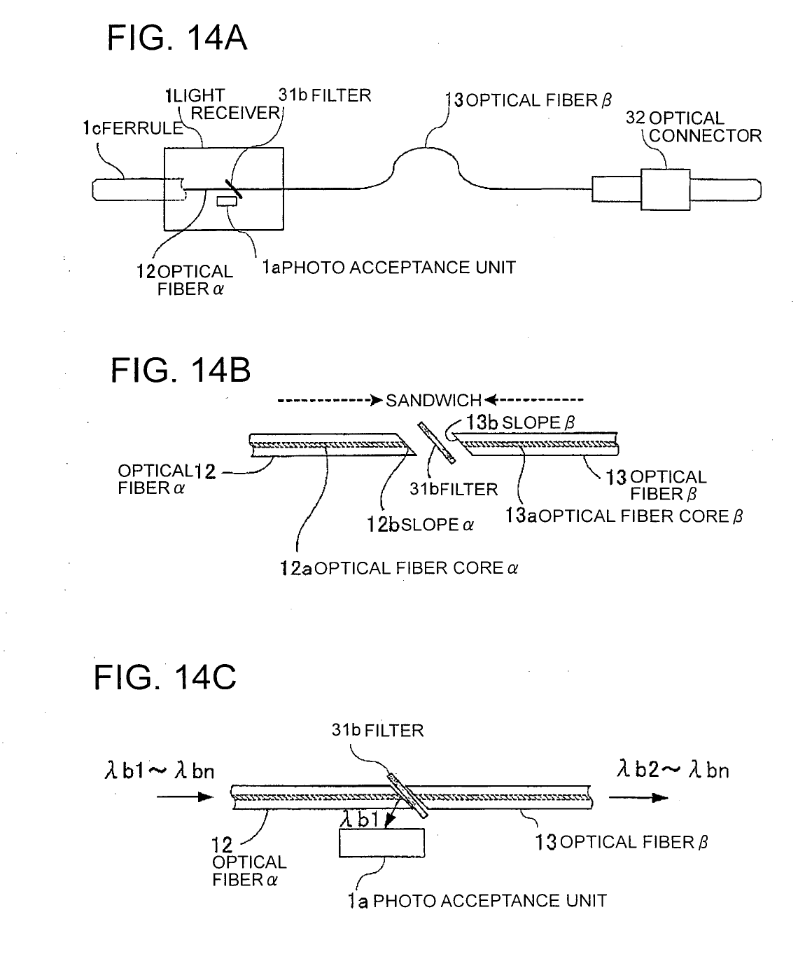

FIGS. 14A, 14B, and 14C are figures which describe an optical drop module according to a ninth embodiment of the invention. FIG. 14A shows a constructional figure of the optical drop module. The light receiver 1 has a receptacle structure which includes the ferrule 1c available to physically contact with an optical connector. The ferrule 1c comprises a through-hole (not shown) to insert an optical fiber α12. The optical fiber α12 is inserted in the through-hole from inside. Part or all of signal lights entering from the ferrule 1c are reflected by the filter 31b which is sandwiched between the optical fiber α12 and an optical fiber β13. These lights are outputted from the optical fiber α12, and enter the photo acceptance unit 1a in the light receiver 1.

Part or all of the signal lights entering from the optical connector 32 pass inside of the light receiver 1 through the optical fiber β13 and the optical fiber α12, and are emitted by the ferrule 1c.

FIGS. 14B and 14C are figures which describe a manufacturing procedure for a part (light output part) to output part or all of signal lights from the optical fiber α12 in the light receiver 1 of FIG. 14A. As shown in FIG. 14B, this light output part is obtained by facing a slope α12b and a slope β13b so that the first optical fiber α12 including the slope α12b and the second optical fiber β13 including the slope β13b are optically coupled, and inserting the filter 31b between the both facing slopes of the core.

FIG. 14C is a figure which illustrates a view that the light receiver is constructed by optically coupling the photo acceptance unit 1a with this light output part. In this figure, signal lights of wavelengths of λb1 to λbn enter from the left side. Only the light of wavelength λb1 is reflected by the filter 31b, and enters the photo acceptance unit 1a.

Due to this construction, in the optical drop module according to the ninth embodiment of the invention, the single wavelength dispersive circuit is not used. In addition, the light receiver 1 has a receptacle structure. Therefore, the optical drop module can be realized with small number of parts compared with in conventional examples. Further, excess parts of the optical fiber to be disposed can be reduced to only one part. Consequently, cost reduction can be realized.

[Tenth Embodiment]

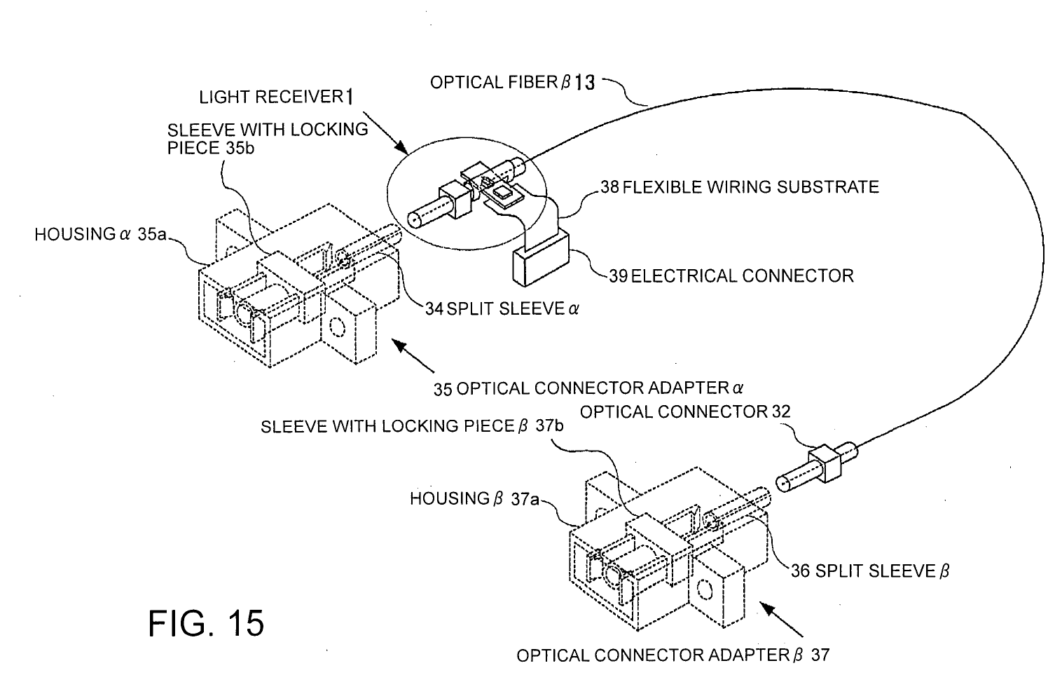

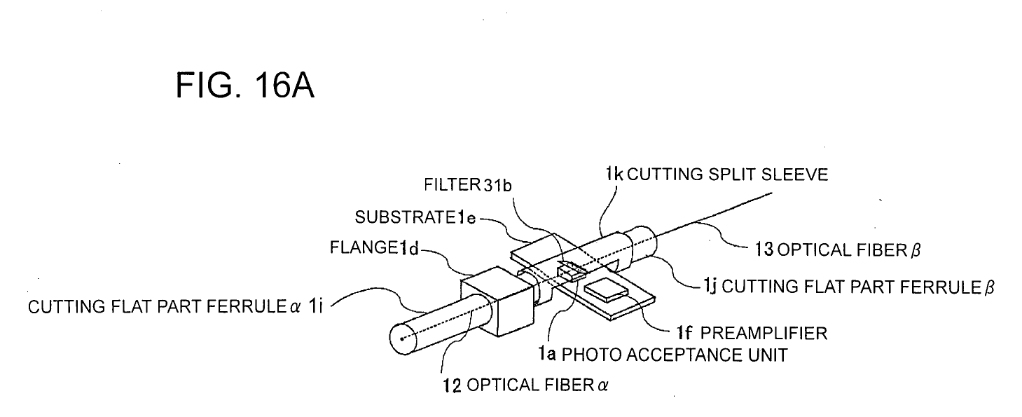

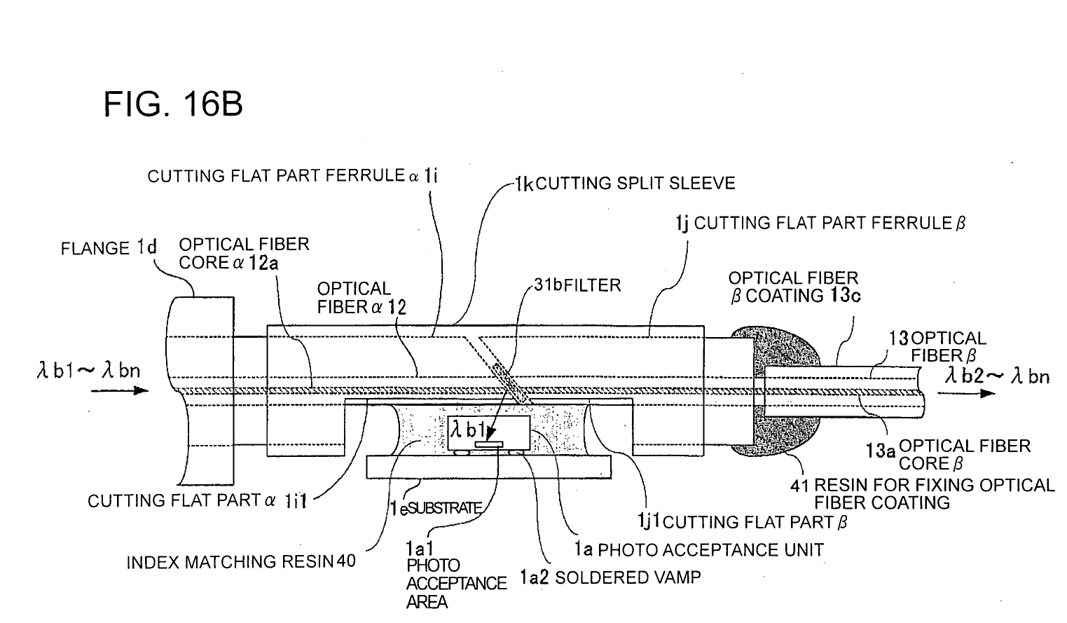

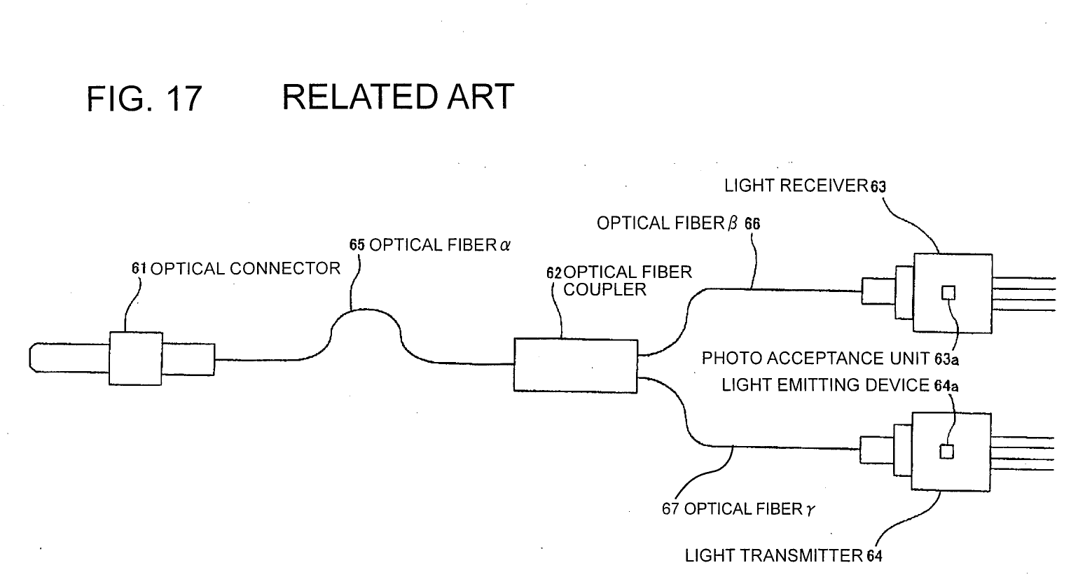

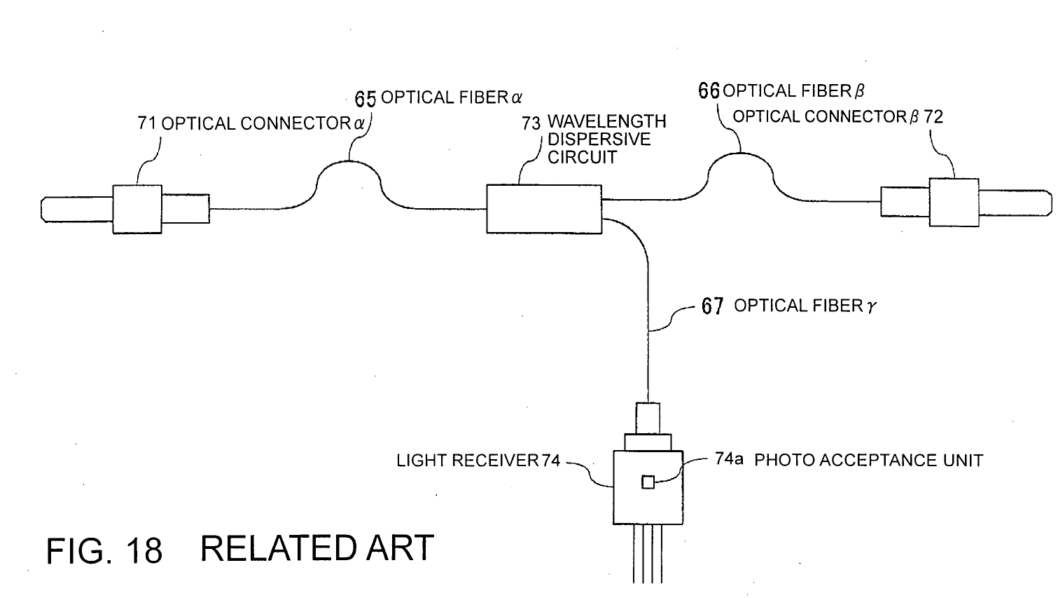

FIGS. 15, 16A, and 16B are figures which describe an optical drop module according to a tenth embodiment of the invention. FIG. 15 shows a constructional figure of the optical drop module. The tenth embodiment shown in this FIG. 15 is one example which shows more specific construction of the light receiver 1 of the foregoing ninth embodiment. In this construction, the light receiver 1 is connected with a master substrate on which the module is mounted through the intermediary of the flexible wiring substrate 38 and the electrical connector 39.

FIG. 16A is a figure to describe a construction of this light receiver 1. FIG. 16B is a cross sectional view which describes in detail a structure in the vicinity of a light output part. In the figures, the following “the first” and the like are omitted. The cutting flat part α1i1 to expose part of a lateral face of the first optical fiber α12 is formed on one end side of the cutting flat part ferrule α1i (hereinafter referred to as the first ferrule as well) having a through-hole to insert the first optical fiber α12. The first optical fiber α12 is let through the first ferrule α1i, and parts thereof protruding from the both ends of the first ferrule α1i are cut. The cutting flat part β1j1 to expose part of a lateral face of the second optical fiber β13 is formed on one end side of the cutting flat part ferrule β1j (hereinafter referred to as the second ferrule as well) having a through-hole to insert the second optical fiber β13. The second optical fiber β13 is let through the second ferrule β1j, and only a part thereof protruding from the cutting flat part β1j1 side of the second ferrule β1j is cut. When the cutting flat part α1i1 of the first ferrule α1i and the cutting flat part β1j1 of the second ferrule β1j are faced so that they are on the same level, both optical fiber end faces on respective cutting flat part sides are processed in the shape of a slope at an angle that the first optical fiber α12 and the second optical fiber β13 are optically coupled. Then, the cutting flat part α1i1 of the first ferrule α1i and the cutting flat part β1j1 of the second ferrule β1j are faced so that they are on the same level. After that, the filter 31b is inserted between the both slopes of the core. The light output part obtained thereby is optically coupled with the photo acceptance unit 1a.

An end face of the first ferrule α1i on the side opposite of the cutting flat part α1i1 is polished to allow the ferrule to physically contact with an optical connector, and the light receiver 1 has a receptacle structure.

The resin 40 (index matching resin) which matches index with the optical fiber is filled between the light output part and the photo acceptance unit 1a. An optical fiber β coating 13c is fixed on the cutting flat part ferrule β1j by the resin for fixing optical fiber coating 41. The flange 1d is installed on the cutting flat part ferrule α1i, in order to engage with a locking piece of the sleeve with locking piece a 35b of the optical connector adapter a 35. The cutting flat part ferrule α1i is connected with the optical connector through the intermediary of the split sleeve α34.

Due to this construction, in the optical drop module according to the tenth embodiment of the invention, the single wavelength dispersive circuit is not used. In addition, the light receiver 1 has a receptacle structure. Therefore, the optical drop module can be realized with small number of parts compared with in conventional examples, and excess parts of the optical fiber to be disposed can be reduced to only one part. Consequently, cost reduction can be realized.

Further, the photo acceptance unit 1a is mounted on the same slave substrate 1e as a preamplifier 1f is, and the slave substrate 1e and a master substrate on which the module is mounted are electrically connected by the flexible wiring substrate 38. Therefore, destruction of the light receiver 1 when inserting or ejecting the optical connector can be prevented, and workability when building into the device can be improved.

In the foregoing sixth to tenth embodiments, descriptions have been given of the optical drop module respectively. A low-cost optical transmission device can be constructed by mounting such an optical drop module on the optical transmission device.

As above, according to the invention, there is an effect that a bidirectional optical module and an optical drop module with small number of parts and low-cost, and an optical transmission device using them can be realized. Therefore, the invention can be widely utilized and useful in optical communications and optical transmission areas.

What is claimed is:

1. A bidirectional optical module comprising:
a light receiver, wherein a photo acceptance unit is optically coupled with a light output part obtained by cutting an optical fiber in the middle thereof aslant a core of the optical fiber, and inserting a filter or a half mirror between obtained cross sections of the core; and
a light transmitter, wherein a light emitting device is optically coupled with one end of the optical fiber,
wherein the light receiver is set to have a receptacle structure, which comprises a ferrule, in which the other end of the optical fiber is inserted from inside, and which can physically contact with an optical connector.

2. A bidirectional optical module comprising:
a light receiver, wherein a photo acceptance unit is optically coupled with a light output part obtained by partly forming a cutting part to expose part of a lateral face of an optical fiber in a ferrule having a thorough-hole to insert the optical fiber, letting the optical fiber through the ferrule, forming a slit at the cutting part, forming cross sections aslant a core of the optical fiber, and inserting a filter or a half mirror between the cross sections of the core; and
a light transmitter, wherein a light emitting device is optically coupled with one end of the optical fiber,
wherein a part protruding from an end face of the ferrule on the other end side of the optical fiber is cut, an end face of the ferrule on the side opposite of the light transmitter-connected side is polished so that the ferrule can physically contact with an optical connector, and the light receiver is set to have a receptacle structure.

3. The bidirectional optical module according to claim 1 or 2, wherein the photo acceptance unit of the light receiver is mounted on the same slave substrate as a subsequent circuit is, and the slave substrate and a master substrate on which the module is mounted are electrically connected by a flexible wiring substrate.

4. The bidirectional optical module according to claim 3, wherein the slave substrate is formed of a three-dimensional substrate.

5. The bidirectional optical module according to claim 4, wherein the three-dimensional substrate has a shape available to engage with a locking piece of an optical connector adapter.

6. The bidirectional optical module according to claim 1 or 2, wherein an index matching resin which is cured by ultraviolet is filled on a light path from the light output part to the photo acceptance unit, and the ferrule is made of a material transparent to ultraviolet by which the index matching resin is cured.

7. A bidirectional optical module comprising:
a light receiver, wherein a photo acceptance unit is optically coupled with a light output part obtained by facing a slope of a first optical fiber whose at least one end is a slope and a slope of a second optical fiber whose at least one end is a slope so that they are optically coupled, and inserting a filter or a half mirror between the facing both slopes of an optical fiber core; and
a light transmitter, wherein a light emitting device is optically coupled with an end of the second optical fiber on the side opposite of the light output part,
wherein a ferrule which has a through-hole to insert the optical fiber and which can physically contact with an optical connector is provided at one end of the first optical fiber on the side opposite of the light output part, the ferrule and the light receiver are integrated, and the light receiver is set to have a receptacle structure.

8. A bidirectional optical module comprising:
a light receiver, wherein a photo acceptance unit is optically coupled with a light output part obtained by,
forming a cutting flat part to expose part of a lateral face of a first optical fiber on one end of a first ferrule having a through-hole to insert the first optical fiber, letting through the first optical fiber, and cutting parts thereof protruding form both ends of the first ferrule,
forming a cutting flat part to expose part of a lateral face of a second optical fiber on one end of a second ferrule having a through-hole to insert the second optical fiber, letting through the second optical fiber, and cutting only a part thereof protruding from the cutting flat part side of the second ferrule,
processing optical fiber ends of the first and the second optical fibers on their cutting flat part sides in the slope shape at an angle that the first optical fiber and the second optical fiber are optically coupled, when the cutting flat parts of the first ferrule and the second ferrule are faced so that they are on the same level, and
facing the cutting flat part sides of the first ferrule and the second ferrule so that they are on the same level, and inserting a filter or a half mirror between the both slopes of an optical fiber core; and
a light transmitter, wherein a light emitting device is optically coupled with an end of the second optical fiber on the side opposite of the light output part,
wherein an end face of the first ferrule on the side opposite of the cutting flat part is polished to allow the ferrule to physically contact with an optical connector, and the light receiver has a receptacle structure.

9. The bidirectional optical module according to claim 7 or 8, wherein the photo acceptance unit of the light receiver is mounted on the same substrate as a subsequent circuit is, and the slave substrate and a master substrate on which the module is mounted are electrically connected by a flexible wiring substrate.

10. The optical transmission device, on which the bidirectional optical module according to any one of claims 1, 2, 7, and 8 is mounted.

11. An optical drop module comprising:
a light receiver, wherein a photo acceptance unit is optically coupled with a light output part obtained by cutting an optical fiber in the middle thereof aslant a core of the optical fiber, and inserting a filter between obtained cross sections of the core,
wherein an optical connector is provided at one end of the optical fiber, a ferrule available to physically contact with an optical connector is provided on the other end, the ferrule and the light receiver are integrated, and the light receiver is set to have a receptacle structure.

12. An optical drop module comprising:
a light receiver, wherein a photo acceptance unit is optically coupled with a light output part obtained by partly forming a cutting part to expose part of a lateral face of an optical fiber in a ferrule having a through-hole to insert the optical fiber, letting the optical fiber through the ferrule, forming a slit at the cutting part, forming cross sections aslant a core of the optical fiber, and inserting a filter between the cross sections of the core,
wherein an optical connector is provided at one end of the optical fiber, a part protruding from an end face of the ferrule on the other end side of the optical fiber is cut, an end face of the ferrule on the side opposite of the optical connector-provided side is polished so that the ferrule can physically contact with an optical connector, and the light receiver is set to have a receptacle structure.

13. The optical drop module according to claim 11 or 12, wherein the photo acceptance unit of the light receiver is mounted on the same slave substrate as a subsequent circuit is, and the slave substrate and a master substrate on which a module is mounted are electrically connected by a flexible wiring substrate.

14. The optical drop module according to claim 13, wherein the slave substrate is formed of a three-dimensional substrate.

15. The optical drop module according to claim 14, wherein the three-dimensional substrate has a shape to engage with a locking piece of an optical connector adapter.

16. The optical drop module according to claim 11 or 12, wherein an index matching resin which is cured by ultraviolet is filled on a light path from the light output part to the photo acceptance unit, and the ferrule is made of a material transparent to ultraviolet which cures the index matching resin.

17. An optical drop module comprising:
a light receiver, wherein a photo acceptance unit is optically coupled with a light output part obtained by facing a slope of a first optical fiber whose at least one end is a slope and a slope of a second optical fiber whose at least one end is a slope so that they are optically coupled, and inserting a filter between the both slopes of an optical fiber core,
wherein an optical connector is provided at an end of the second optical fiber on the side opposite of the light output part, a ferrule which has a through-hole to insert the optical fiber and which can physically contact with an optical connector is provided at an end of the first optical fiber on the side opposite of the light output part, the ferrule and the light receiver is integrated, and the light receiver is set to have a receptacle structure.

18. An optical drop module comprising:
a light receiver, wherein a photo acceptance unit is optically coupled with a light output part obtained by,
forming a cutting flat part to expose part of a lateral face of a first optical fiber on one end of a first ferrule having a through-hole to insert the first optical fiber, letting through the first optical fiber, and cutting parts thereof protruding form both ends of the first ferrule,
forming a cutting flat part to expose part of a lateral face of a second optical fiber on one end of a second ferrule having a through-hole to insert the second optical fiber, letting through the second optical fiber, and cutting only a part thereof protruding from the cutting flat part side of the second ferrule,
processing optical fiber ends of the first and the second optical fibers on their cutting flat part sides in the slope shape at an angle that the first optical fiber and the second optical fiber are optically coupled, when the cutting flat parts of the first ferrule and the second ferrule are faced so that they are on the same level, and
facing the cutting flat part sides of the first ferrule and the second ferrule so that they are on the same level, and inserting a filter between the both slopes of an optical fiber core,
wherein an optical connector is provided at one end of the second optical fiber on the side opposite of the light output part, an end face of the first ferrule on the side opposite of the cutting flat part is polished to allow the ferrule to physically contact with an optical connector, and the light receiver is set to have a receptacle structure.

19. The optical drop module according to claim 17 or 18, wherein the photo acceptance unit of the light receiver is mounted on the same slave substrate as a subsequent circuit is, and the slave substrate and a master substrate on which the module is mounted are electrically connected by a flexible wiring substrate.

20. The optical transmission device, on which the optical drop module according to any one of claims 11, 12, 17, and 18 is mounted.
